(19) United States
(12) Patent Application Publication
(10) Pub. No.: US 2026/0105263 A1
(43) Pub. Date: Apr. 16, 2026

(54) TASK AND MOTION PLANNING VIA LANGUAGE MODEL INFERRED CONSTRAINTS

(71) Applicant: NVIDIA Corporation, Santa Clara, CA (US)

(72) Inventors: Nishanth Kumar, Cambridge, MA (US); Fabio Tozeto Ramos, Seattle, WA (US); Caelan Garrett, Seattle, WA (US)

(21) Appl. No.: 19/200,495

(22) Filed: May 6, 2025

Related U.S. Application Data
(60) Provisional application No. 63/707,687, filed on Oct. 15, 2024.

(51) Int. Cl. G06F 40/40; A63F 13/57; B25J 9/16; B60W 60/00; G05D 1/229; G05D 101/15

(52) U.S. Cl. CPC G06F 40/40; A63F 13/57; B25J 9/1658; B60W 60/0025; G05D 1/229; G05D 2101/15

(57) ABSTRACT

Classical Task and Motion Planning (TAMP) systems are capable of solving complex and long-horizon tasks by leveraging models of a robot and its environment to explicitly reason about both discrete and continuous values in the robotics problem. While such systems are powerful on the set of problems they have been designed for, they do not transfer to novel problems for which their models are unspecified. The present disclosure integrates a language model together with a TAMP system for solving novel robotics problems, including using the language model to infer constraints for a specified robotic goal which can then be used by the TAMP system for generating a motion plan to achieve the robotic goal.

### RELATED APPLICATION(S)

This application claims the benefit of U.S. Provisional Application No. 63/707,687 (Attorney Docket No. NVIDP1423+/24-SE-1336US01), titled “OPEN-WORLD TASK AND MOTION PLANNING VIA VISION-LANGUAGE MODEL INFERRED CONSTRAINTS” and filed Oct. 15, 2024, the entire contents of which is incorporated herein by reference.

### TECHNICAL FIELD

The present disclosure relates to task and motion planning for robotics.

### BACKGROUND

The advent of foundation models trained on internet-scale data has led to unprecedented progress on traditionally-hard tasks in vision and natural language. Current Large Language Models (LLMs) and Vision-Language Models (VLMs) are able to complete text from partial specifications, answer questions about images, and even solve challenging word problems that require reasoning and common sense. This impressive performance has inspired several systems that attempt to use existing pretrained models in robotics. Such systems exhibit impressive flexibility: unlike classical robotics approaches, they are able to accomplish novel goals specified by natural language or images. However, currently no publicly available foundation models exist that can directly output continuous values (e.g. joint angles, grasps, placements), which are that are sufficient for full control of a robot to interact with the physical world.

In contrast, classical Task and Motion Planning (TAMP) systems are capable of solving complex and long-horizon tasks ranging from setting a dining table to three-dimensional (3D) printing of complex structures. These systems leverage planning models of the robot and its environment to explicitly reason about both discrete and continuous values in robotics problems. While such systems are powerful on the set of problems they have been designed for, they do not transfer to novel problems for which their models are unspecified. Enabling a TAMP system to solve novel problems often requires manually extending the underlying model, which is tedious and not scalable when operating in unstructured human environments.

There is a need for addressing these issues and/or other issues associated with the prior art. For example, there is a need use language models to infer constraints for a specified robotic goal that can then be used by a TAMP system for generating a motion plan to achieve the robotic goal.

### SUMMARY

A method, computer readable medium, and system are disclosed to generate a robotic motion plan. A natural language prompt describing a robotic goal is processed, using a language model, to generate constraints for a task and motion planning (TAMP) system. A motion plan that respects the constraints and that achieves the robotic goal is generated by the TAMP system.

### BRIEF DESCRIPTION OF THE DRAWINGS

FIG. 1 illustrates a method for generating a robotic motion plan, in accordance with an embodiment.

FIG. 2 illustrates a system for generating a robotic motion plan, in accordance with an embodiment.

FIG. 3 illustrates an exemplary implementation of the system of FIG. 2, in accordance with an embodiment.

FIG. 4 illustrates a hybrid constraint network, in accordance with an embodiment.

FIG. 5 illustrates a system including a subsystem as depicted in FIG. 2, in accordance with an embodiment.

FIG. 6 illustrates a method of a robotic system using a robotic motion plan, in accordance with an embodiment.

FIG. 7A illustrates inference and/or training logic, according to at least one embodiment.

FIG. 7B illustrates inference and/or training logic, according to at least one embodiment.

FIG. 8 illustrates training and deployment of a neural network, according to at least one embodiment.

FIG. 9 illustrates an example data center system, according to at least one embodiment.

### DETAILED DESCRIPTION

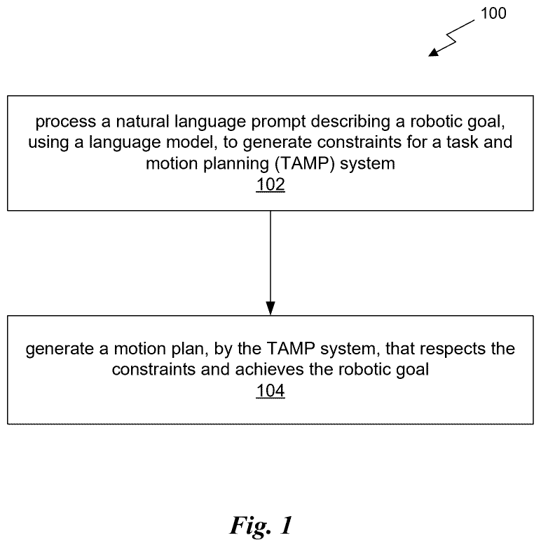

FIG. 1 illustrates a method 100 for generating a robotic motion plan, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, a natural language prompt describing a robotic goal is processed, using a language model, to generate constraints for a task and motion planning (TAMP) system. The natural language prompt refers to a text that describes the robotic goal and that is input in a natural language. In an embodiment, the natural language prompt may be input by a user. In an embodiment, the natural language prompt may reference a particular (e.g. type of) robotic system that is to achieve the robotic goal. In various embodiments, the robotic system, also referred to herein as a “robot”, may be a real-world robotic system, such as a robotic arm or an autonomous driving vehicle, or may be a virtual robotic system, such as a character or other movable object in a video game.

The robotic goal refers to a task to be performed by a robotic system. The robotic goal may define “what” it is that the robotic system is supposed to do, such as for example an end result that the robotic system is to achieve or an end state for the robotic system. The robotic goal may at least partially exclude details on “how” the robotic system can or should achieve the robotic goal, such as for example steps for the robotic system to take to achieve the robotic goal.

As mentioned, the natural language prompt describing the robotic goal is processed, using a language model, to generate constraints for a TAMP system. The language model refers to a machine learning model that has been trained to predict constraints for a TAMP system given a robotic goal. In an embodiment, the language model may be a large language model (LLM). In another embodiment, the language model may be a vision-language model (VLM).

The constraints refer to criteria to be used to ground the TAMP system when generating a motion plan for achieving the robotic goal. Thus, in an embodiment, the constraints may be generated in a vocabulary of (i.e. supported by) the TAMP system. The motion plan, which may also be considered a manipulation plan for a robot interacting with a world, will be described in more detail below.

In an embodiment, the constraints may be restrictions for the motion plan. In an embodiment, the constraints may be requirements for the motion plan. In an embodiment, the constraints may define goal conditions. For example, the constraints may include at least one continuous constraint over a decision variable to define the goal conditions. In another embodiment, the constraints may define a partial plan (e.g. a partial motion plan). For example, the constraints may include at least one discrete constraint over an action sequence to specify the partial plan.

In an embodiment, the language model may be grounded with a set of reachable actions and a set of reachable literals representing reachable states. In an embodiment, the set of reachable actions and the set of reachable literals may both be grounded from a given initial state. The given initial state may refer to a physical state of the robotic system. For example, the language model may determine as a first one of the constraints a subset of the reachable literals that conjunctively must hold to satisfy the robotic goal described by the natural language prompt, and may determine as a second one of the constraints a partial plan comprised of a subset of the reachable actions that achieve the robotic goal described by the natural language prompt.

In operation 104, a motion plan that respects the constraints and that achieves the robotic goal is generated by the TAMP system. The TAMP system refers to a system (e.g. software and/or hardware) that is preconfigured to provide task and motion planning for at least one type of robotic system. The motion plan refers to a definition of one or more steps (e.g. actions, movements, etc.) for the robotic system to take to achieve the robotic goal. The motion plan may define a sequence for the one or more steps, in an embodiment. In an embodiment, the motion plan may be generated in a vocabulary of the robotic system.

In an embodiment, a search space of the TAMP system may be constrained (i.e. per the constraints) when generating the motion plan for achieving the robotic goal. Just by way of example, where the constraints include a partial plan, the TAMP system may be constrained to generating a motion plan that includes the partial plan as a subsequence. As another example, where the language model predicts a partial plan and conjunctive reachable goal literals, these predictions may be used to “constrain” the TAMP search space, ensuring it produces a motion plan that achieves the robotic goal.

Further to the method 100 described herein, the motion plan may be output to the robotic system. In an embodiment, outputting the motion plan to the robotic system may cause the robotic system to move in accordance with the motion plan to achieve the robotic goal. For example, the robotic system may perform the one or more steps defined by the motion plan to achieve the robotic goal.

Further to the method 100 described herein, the language model may be iteratively reprompted to refine the constraints. In this embodiment, the refined constraints may be used to ground (e.g. constrain, etc.) the generation of the motion plan by the TAMP system. In an embodiment, the language model may be reprompted based on a function that tests over a set of sampled continuous variables of a domain of the constraints' parameters. In an embodiment, the function may be generated by the language model or by another language model (e.g. another LLM or VLM). Just by way of example, the actions and reachable literals may optionally have undefined continuous constraints, which the language model may be asked to implement in the form of a test by writing code. Additional embodiments regarding the constraint refinement will be described below in detail.

Further embodiments will now be provided in the description of the subsequent figures. It should be noted that the embodiments disclosed herein with reference to the method 100 of FIG. 1 may apply to and/or be used in combination with any of the embodiments of the remaining figures below.

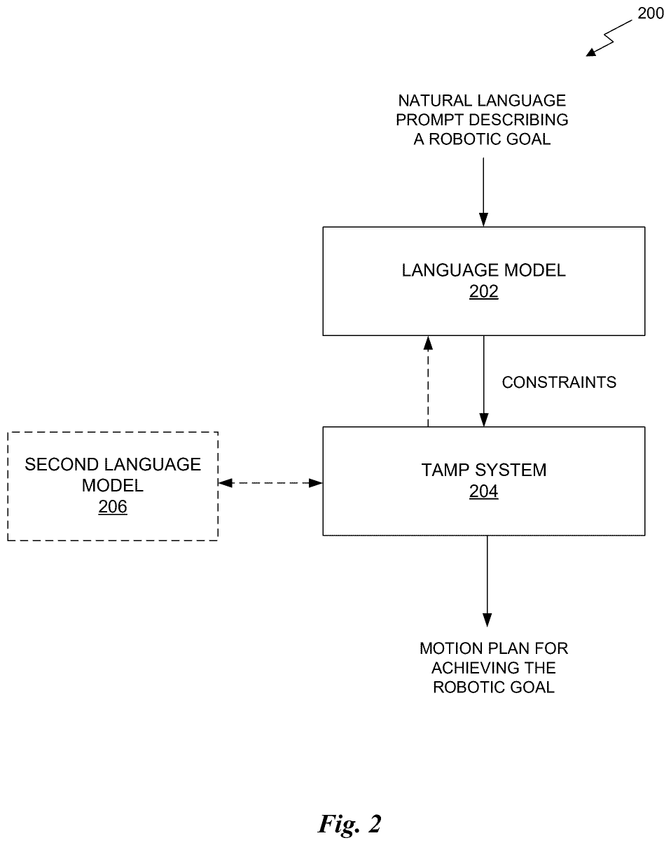

FIG. 2 illustrates a system 200 for generating a robotic motion plan, in accordance with an embodiment. The system 200 may be implemented to carry out the method 100 of FIG. 1, in an embodiment. The definitions and embodiments provided above may equally apply to the present description.

As shown, the system 200 includes a language model 202. The language model 202 may be a LLM or VLM, which may be implemented in software and/or hardware. The system 200 also includes a TAMP system 204. The TAMP system 204 may be implemented in software and/or hardware. The language model 202 and the TAMP system 204 may be located on a same computing system, in an embodiment. In another embodiment, the language model 202 and the TAMP system 204 may be located on different computing system and may communicate (i.e. input and/or output data), as described herein, via a network.

The language model 202 is configured to process a natural language prompt describing a robotic goal to generate constraints for the TAMP system 204. The TAMP system 204 is configured to generate a motion plan that respects the constraints and that achieves the robotic goal.

The present system 200 combines the complementary benefits of a language (e.g. foundation) model 202 and a TAMP system 200 to tackle long-horizon manipulation tasks that are open world, namely where the vocabulary of objectives is unbounded. Specifically, the robotic goal can be specified in natural language, which may involve concepts that the underlying TAMP system 204 does not have built-in but which can be achieved by chaining together robot motion primitives the TAMP system 204 possesses.

As an example, a TAMP system 204 that is capable of accomplishing pick-and-place tasks expects goals in the form of logical expressions involving predicates like On(apple, plate). However, a natural language prompt stating “Put the orange on the table where the apple initially is” cannot be expressed in terms of On, and thus there would be no way the TAMP system 204 could solve it, even though it could be accomplished by a sequence of pick-place primitives. A pure language model 202-based system would also struggle with this task since it must not only predict that the apple needs to be moved out of the way before the orange can be placed, but also must predict the continuous robot motions that realize this.

However, in the present system 200, the discrete-continuous planning of the TAMP system 204 and common sense reasoning of the language model 202 are integrated through the contract of constraints. In particular, the language model 202 is capable of mapping a very wide range of open world expressions into discrete action sequences (e.g. that a potato must be cooked before it can be served) and code that represents continuous constraints over important decision variables (e.g. valid poses of the egg such that it is inside an oven). These constraints can be readily integrated with existing constraints (e.g. avoiding collisions, respecting kinematics) within the (e.g. off-the-shelf) TAMP system 204. Thus, the overall system 200 is able to generate solutions that not only respect constraints derived from the open world robotic goal, but also are physically feasible on robotic system.

The present system 200 may be referred to as OWL-TAMP (Open-World Language-based TAMP), which integrates open world concepts via constraint generation into the TAMP system 204 with traditional robotics operations and constraints. Embodiments of this framework, as described in more detail below, may include: (1) a method for generating constraints on action sequences to specify partial plans with language descriptions; (2) a method for generating constraints on continuous variables affected within the partial plan from (1); and (3) combining both (1) and (2) within the TAMP system 204. The system 200 enables a robotic system, whether a real-world robot or a virtual robot, to solve complex, long-horizon manipulation tasks specified through language directly from sensor input.

### Problem Setup

A model-based mixed discrete-continuous planning approach is adopted to control a robot to solve open-world tasks. A planning model of the TAMP system 204 is employed which contains commonplace manipulation primitives applicable across a very wide range of tasks and a language model 202 (which may also be referred to herein as a VLM) is leveraged to extend the planning model to reason about novel, task-specific dynamics and constraints.

The underlying planning model is configured to capture generic dynamics and constraints (e.g. kinematic constraints and reachability, collision constraints) that apply across any task a robot might be faced with, while the language model 202 is configured to provide additional task-specific constraints (e.g. that an object must be placed in a pan for it to be ‘cooked’, that serving coffee in a mug requires that mug be upright) that serve to specialize the planning model to the given situation.

In an embodiment, the system 200 may be modeled using a Planning Domain Definition Language (PDDL)-style factored action language, which represents states and actions in terms of predicates. However, the system 200 is not limited to this representational choice, but may also be implemented with any of multiple different planning frameworks, such as PDDLStream and SeSaME. In PDDL, state variables are represented as literals, true or false evaluations of predicates for particular values of their parameters.

In the following description, a single robot acting in a simplified manipulation domain is used as a pedagogical running example. Because robotics inherently involves continuous values, discrete parameter types are considered as well as continuous ones, namely:
obj—a discrete manipulable object o,
conf—a continuous robot configuration q∈R^{d},
traj—a continuous robot trajectory comprised of a sequence n of configurations τ∈R^{nd},
grasp—a continuous object grasp pose g∈SE(3), and
pose—a continuous object placement pose p∈SE(3).

The fluent predicates, i.e. predicates with truth values that can change over time, are:
AtConf (q: conf) —the robot is currently at configuration q,
HandEmpty( ) —the robot's hand is currently empty,
AtPose(o: obj, p: pose) —object o is currently at placement pose p, and
AtGrasp(o: obj, g: grasp) —object o is currently grasped with grasp pose g.

From these predicates, states can be described, which are represented by true literals. For example, the initial state in a domain with a single object apple might be: s₀=[AtConf(q₀), HandEmpty( ), AtPose(apple, p₀), . . . ].

Parameterized actions, which the robot can apply to affect a change in a state, are defined by a name, list of typed parameters, list of static literal constraints (con) that the parameters must satisfy, list of fluent literal preconditions (pre) that must hold before applying the action, and list of fluent literal effects (eff) that hold in the state after applying the action. The actions “move” (Example 1) and “attach” (Example 2) model the robot moving between two configurations and attaching an object to itself, for example, by grasping it.

### Example 1

move(q₁: conf, q₂: conf, τ: traj)
   con: [Motion(q₁, τ, q₂)]
   pre: [AtConf(q₁)]
   eff: [AtConf(q₂), ¬AtConf(q₁)]

### Example 2

attach(o: obj, p: pose, g: grasp, q: conf)
   con: [Kin(q, o, g, p)]
   pre: [AtPose(o, p), HandEmpty( ), AtConf(q)]
   eff: [AtGrasp(o, g), ¬AtPose(o, p), ¬HandEmpty( )]

Ground action instances of these parameterized actions must satisfy the following static predicates: Motion(q₁: conf, τ: traj, q₂: conf) —τ is a valid trajectory that connects configurations q₁ and q₂, and Kin(q: conf, o: obj, g: grasp, p: placement) —configuration q satisfies a kinematics constraint with placement pose p when object o is grasped with grasp pose g.

### Open World Predicates and Actions

A small and finite set of traditional TAMP predicates and actions have been described above. These correspond to generic dynamics and constraints that a robot encounters due to its embodiment in the physical world. However, as also described above, the system 200 is configured for modeling and planning with open-world concepts that are environment or task specific. To support open-world concepts, select predicates and actions are parameterized with an additional type, a description d. Descriptions modify the semantics of predicates and actions to respect an open-world natural-language instruction. Descriptions help specialize the overly general robot interactions (e.g. moving without collision, grasping stably) in the traditional planning model of the TAMP system 204 to achieve novel outcomes. Overall, this strategy can be seen as bootstrapping an unbounded set of predicates and actions from a finite set by leveraging language itself as a parameter.

Consider the VLMPose(d: description, o: obj, p: pose) constraint, which is true if object o at placement p satisfies description d. Some example descriptions d are: “orange at the center of the table”, “orange at the apple's initial location”, and “orange as far away from the robot as possible”. Using this constraint, a detach action is formulated (Example 3), which involves the robot releasing object o according to the description d. This can correspond to placing the object on a surface, stacking the object on another object, dropping the object in a bin, inserting the object into an outlet, etc.

### Example 3

detach(d: description, o: obj, g: grasp, p: pose, q: conf)
   con: [Kin(q, o, g, p), VLMPose(d, o, p)]
   pre: [AtPose(o, p), HandEmpty( ), AtConf(q),
      ¬∃o′, p′. AtPose(o′, p′)∧Collision(o, p, o′, p′)]
   eff: [AtGrasp(o, g), ¬AtPose(o, p), ¬HandEmpty( )]

Additional parameterized actions that model different interaction types can also be defined, such as an action that moves a cup through waypoints to fill it up or pour out of it.

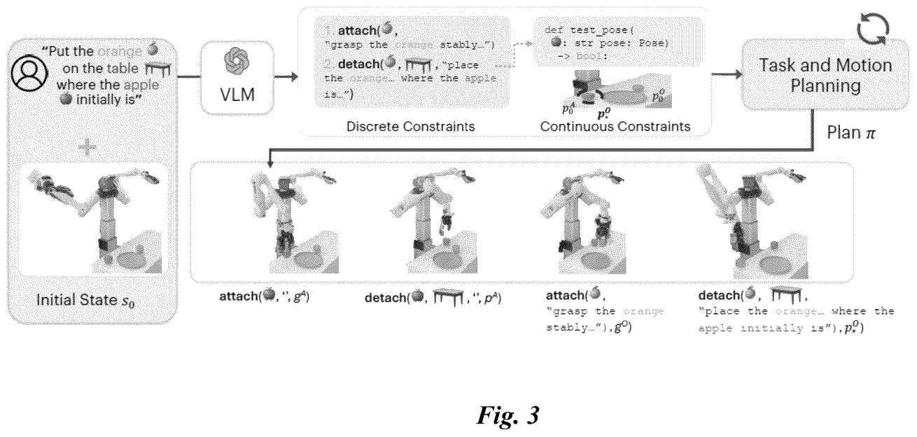

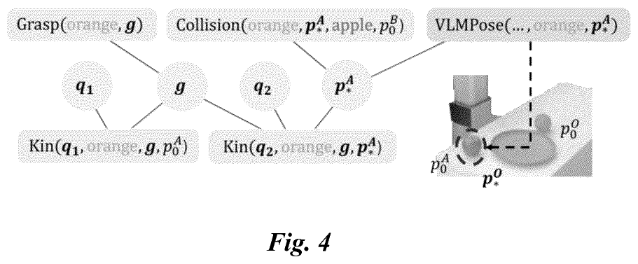

The system 200 allows for planning with both traditional robot constraints as well as task-specific open-world constraints. Consider the problem in FIG. 3, where the goal is to ‘put the orange on the table where the apple initially is”. FIG. 4 (left) displays the simplified constraint network, a bipartite graph from free action parameters (in bold) to the action constraints they are involved in (conf), induced by a plan that directly picks and places the apple:

$$π = [ ... , attach ( apple , {p}_{0}^{A} , g , {q}_{1} ) , ... , \\ detach ( {}^{‶} where the green block {is}^{″} , apple , {p}_{*}^{A} , g , {q}_{2} ) ] .$$

This constraint network is unsatisfiable because the VLMPose constraint restricts the set of placements that satisfy the task and the Collision constraint prevents unsafe placements. But through the use of the TAMP system 200, this approach can backtrack over candidate plans that first move the apple to eventually find a satisfiable constraint network and ultimately a solution.

TAMP with Open World Concepts

The system 200 addresses TAMP problems (s₀, A, g) described by an initial state s₀, set of parameterized actions A, and goal g. Unlike traditional TAMP problems, the goal g is not a logical formula over literals but rather is a goal description provided in natural language (e.g. English) text. Thus, solving such problems requires translating g into some form that can be used within the TAMP system 204.

One approach to this translation would be to directly prompt a VLM to output some logical formula over literals (which we will denote as G) from the goal description g. Given this, one could simply call an off-the-shelf TAMP system to achieve G. While this approach is straightforward, and powerful, it is limited in the kinds of tasks it is able to express in at least two ways: (1) it can only define a goal state to achieve and cannot specify intermediate behaviors or states that need to occur before the goal, and (2) it can only express goals in terms of predicates that are already built into the TAMP system 204.

Consider a TAMP system capable of solving generalized rearrangement problems involving predicates: Supporting(o₁, o₂), where Supporting corresponds to o₁ being either on top of or inside o₂. Now suppose the goal description: “Cook the strawberry by putting it in the pan, then finally serve it in the bowl” is provided. The correct goal translation would be Supporting(strawberry, bowl), but this does not capture the fact that the strawberry needs to be placed in the pan first. Suppose the goal description: “Can you setup the cup on the table so I can properly pour coffee into it?” is separately provided. The TAMP system 204 has no predicate corresponding to Upright(o₁): the closest possible translation would be Supporting(mug, table), which does not fully capture the intent of the goal description (and also happens to be already true in the initial state).

The system 200 addresses these limitations in the expressivity of direct translation by instead translating g into more flexible discrete and continuous constraints (as depicted in FIG. 3). Specifically, the language model 202 is first prompted to supply a set of discrete constraints over open world action orderings, and then induce continuous constraints in the form of code for particular predicates (such as VLMPose) that appear in the effects or constraints of action definitions used as part of our first stage. These constraints are then incorporated into the TAMP system 204 such that it only yields plans that satisfy these constraints. Intuitively, these constraints will be task specific and enable the system 200 to achieve tasks it otherwise could not. Conversely, through using a TAMP system 204, OWL-TAMP inherits theoretical guarantees with respect to the non-language model constraints such as plan soundness, which is critical for safety, and probabilistic completeness. In the cooking task mentioned above, generating a discrete constraint that any valid plan should execute a detach(strawberry, pan) action before a detach(strawberry, bowl) action would be sufficient to enable the TAMP system 204 to solve the task. Similarly, in the fruit sorting task, all that is required is a continuous constraint on the outcome of every detach(fruit) for a TAMP system 204 to accomplish the underlying goal.

In the following, the procedure for discrete constraint generation is described as well as the method for generating continuous constraints given initial discrete constraints.

Generating Discrete Planning Constraints with a Language Model 202

Given a goal description g, the language model is prompted to generate a partial plan that serves as a discrete constraint on the space of TAMP system 204 solutions. To enable this, a natural language description of each available action is associated with that particular action. Although the language model 202 could be directly prompted for relevant actions and goals, without a list of candidates, the language model 202 is likely to be syntactically and semantically inaccurate. Instead, the set of reachable actions A and literals L available to the TAMP system 204 are grounded before prompting the language model 202 to return values in these sets. Relaxed planning from the initial state s₀ may be used to simultaneously ground and explore the sets of reachable actions A and literals L. When instantiating continuous parameters, placeholder values, such as optimistic values, may be used to ensure a finite set of actions are instantiated. Similarly, placeholders may be used for description parameters.

Algorithm 1 presents the language model 202 partial plan generation pseudocode.

Algorithm 1

1: procedure VLM-TASK-REASONING(s₀,A, g)
2: A ← GROUND-ACTIONS(s₀,A)
3: L ← s₀ ∪ {1 | a ∈ A. 1 ∈ e.eff }
4: [a₁, ..., aₙ, l₁, .., lₘ] ← QUERY-VLM(“What partial plan using
actions {A} for goal literals {L} achieves goal {g}?”)
5: for i ∈ [1, n − 1] do
6: aᵢ.eff ← aᵢ.eff ∪ {Executed(i)}
7: aᵢ₊₁.pre ← aᵢ₊₁.pre ∪ {Executed(i)}
8: aₙ.eff ← aₙ.eff ∪ {Executed(n)}
9: G ← {l₁, .., lₘ}
10: return SOLVE-TAMP(s₀, A,G ∪ { Executed(n)})

It takes in a TAMP problem [symbol] s₀, A, g [symbol] , where g is a text goal description. It first grounds the set of actions A reachable from so using GROUND-ACTIONS. Then, it accumulates the set of reachable literals L by taking the effects of all actions A. These sets can be filtered by action or predicate type if it is desired to focus language model 202 assistance on specific aspects of the planning problem. Then, it prompts QUERY-VLM for a partial plan [a₁, . . . , aₙ, l₁, . . . , lₖ] using actions aⱼ∈A and goal literals lⱼ∈Lₘ that achieve the goal description g. Importantly, the language model 202 fills in the description parameter d for each of these actions. The original TAMP problem is then transformed to force solutions to admit the partial plan as a subsequence. Specifically, a predicate EXECUTED is created which models whether the ith action in the plan was executed and EXECUTED is added to the effects of action aᵢ and the preconditions of action aᵢ₊₁. Finally, the planning goal is defined as G={lᵢ, . . . , lₘ}⊆L and EXECUTED(n), which indicates that all actions have been executed and the transformed TAMP problem is solved with a generic TAMP algorithm of the TAMP system 204.

Consider the cooking problem mentioned above where g=“Cook the strawberry by putting it in the pan, then finally serve it in the bowl”. Suppose the language model 202 returns no goal literals, but just the partial plan:

$$\vec{π} = [ detach ( make sure the apple is securely inside the {skillet}^{″} , \\ apple , ... ) , \text{} detach ( {}^{‶} place on teh {plate}^{″} , apple , ... ) , ... ] .$$

Although the VLM plan \vec{π} does capture the intent of the task (i.e., to place the apple in the pan before serving it), this plan is not legal because objects must be picked with the attach action before they can be detached. Fortunately, the underlying TAMP system 204 models this, and thus providing this partial plan, along with the generated Executed predicates, to the TAMP system 204 will result in the TAMP system 204 generating legal plans that are at least 8 actions long.
   Grounding Continuous Constraints with a Language Model

The embodiments described above generate actions with language parameters fully specified. However, in order to correctly apply these actions, the manner in which the language parameter should affect legal action parameter values needs to be interpreted. More specifically, an implementation may be provided for any constraint fluents (such as the VLMPose(d, o, p) fluent introduced above) that use the language description d.

For example, consider the coffee task (i.e. where g=“Can you setup the cup on the table so I can properly pour coffee into it?”), and suppose the discrete generation procedure has produced a plan that contains the following action: detach (“place the mug stably on the table ensuring it is upright and positioned to receive the coffee”, mug, . . . ). To properly implement this action, it must be ensured that the placement pose p of the detach action obeys the description d of being “stably on the table and upright”. To this end, the language model 202, or another language model 206, is prompted to generate code to implement a test on the pose p directly that outputs a Boolean value (and can thus be used as part of VLMPose), per Example 4.

### Example 4

```
def test_poses(p) −> bool:
  ontop_table_bounds =
    modify_pose_bounds_to_be_ontop
    _of_object(‘mug’, ‘table’)
  mug_on_table =
    position_within_bounds(mug.pose,
    ontop_table_bounds)
  upright_orientation = abs(mug.pose.roll)
    < 0.1 and abs(mug.pose.pitch) < 0.1
  return mug_on_table and
    upright_orientation
```

Given such a function, the VLMPose(d, o, p) predicate can be implemented by simply calling this function and passing in the pose p at which the mug object is being placed. The description d is passed into the language model 202 or 206 to generate this function. Given this implementation on VLMPose, the TAMP system 204 will be constrained to solutions that respect this continuous constraint, in line with the intent of the task. Although the description herein focuses on Boolean functions as action constraints, this approach can also be applied to nonnegative functions as action costs to, for example, minimize the distance from a placement to a table edge.

In an embodiment, the language model 202 may also output continuous constraints corresponding to the goal description g itself, and then these may be used to output constraints on each of the discrete actions. Its output is then fed from this step as part of the prompts for it to output constraints on every other action with description d and a constraint fluent requiring a language model 202 implementation.

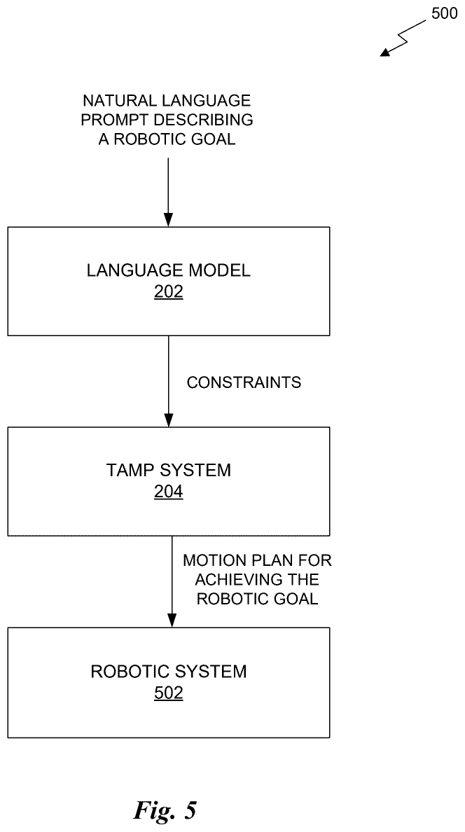

FIG. 5 illustrates a system 500 including a subsystem as depicted in FIG. 2, in accordance with an embodiment. The system 200 may be implemented to carry out the method 100 of FIG. 1, in an embodiment. The definitions and embodiments provided above may equally apply to the present description.

As described above with respect to FIG. 2, the present system 500 includes, as a subsystem, both a language model 202 and a TAMP system 204. The language model 202 is configured to process a natural language prompt describing a robotic goal to generate constraints for the TAMP system 204. The TAMP system 204 is configured to generate a motion plan that respects the constraints and that achieves the robotic goal.

The present system 500 also includes a robotic system 502. The robotic system 502 may be implemented in software and/or hardware. The language model 202 and/or the TAMP system 204 may be implemented as components of the robotic system 502. For example, the language model 202 and/or the TAMP system 204 may be implemented within a computer system of the robotic system 502. In another embodiment, the language model 202 and/or the TAMP system 204 may be located on different computing system than the robotic system 502, in which case such computing system and robotic system 502 may communicate (i.e. input and/or output data), as described herein, via a network.

The robotic system 502 is configured to move in accordance with the motion plan to achieve the robotic goal. In an embodiment, the robotic system 502 may be a real-world robotic system that moves in the real-world in accordance with the motion plan to achieve the robotic goal. For example, the real-world robotic system 502 may be a robotic (e.g. articulated) arm that moves, grasps real-world objects, transports real-world objects, repositions real-world objects, etc. per the motion plan. As another example, the real-world robotic system 502 may be an autonomous driving vehicle that drives in the real-world (e.g. accelerates, decelerates, stops, turns, changes lanes, etc.) per the motion plan.

In another embodiment, the robotic system 502 may be a virtual robotic system that moves in a virtual world in accordance with the motion plan to achieve the robotic goal. For example, the virtual robotic system 502 may be a character or other movable object in an application that moves (e.g. as depicted in a user interface) per the motion plan. The application may be a video game, virtual reality application, augmented reality application, simulation application, etc.

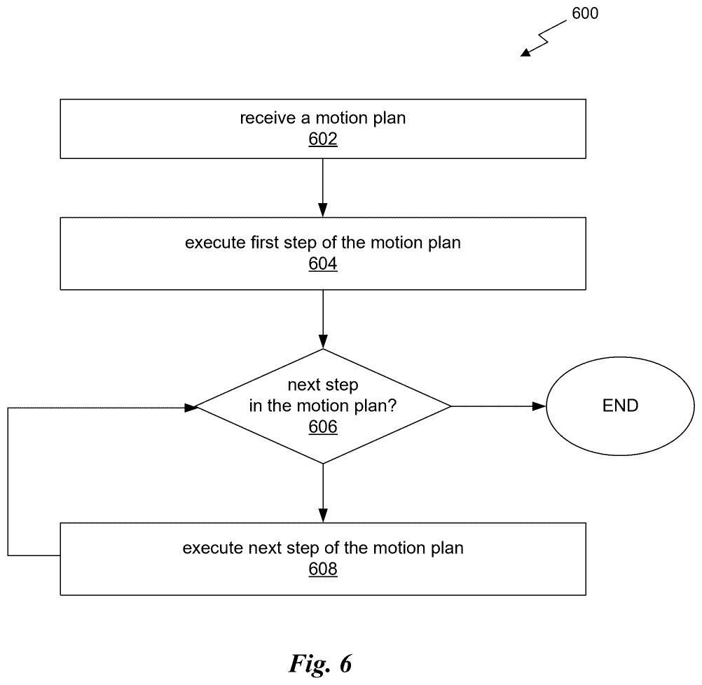

FIG. 6 illustrates a method 600 of a robotic system using a robotic motion plan, in accordance with an embodiment. The method 600 may be carried out by the robotic system 502 of FIG. 5. Again, the definitions and embodiments provided above may equally apply to the present description.

In operation 602, a motion plan is received. The motion plan may be generated per the method 100 of FIG. 1 and/or by the system 200 of FIG. 2. In the present embodiment, the motion plan is comprised of a sequence of steps to be executed (e.g. performed, etc.) by the robotic system. In operation 604, a first step in the motion plan is executed (e.g. performed, etc.). In decision 606, it is determined whether the motion plan includes a next step. When it is determined that the motion plan includes a next step, then the next step is executed in operation 608 and the method 600 then returns to decision 606. Once it is determined that the motion plan does not include a next step, then the method 600 ends.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

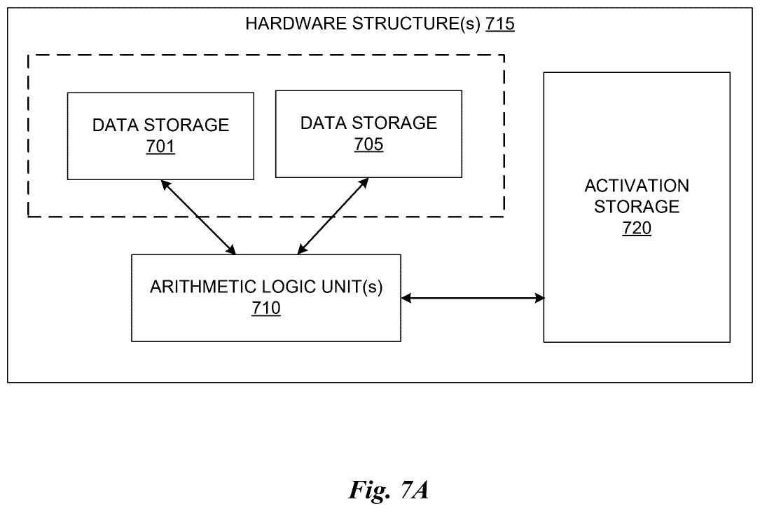

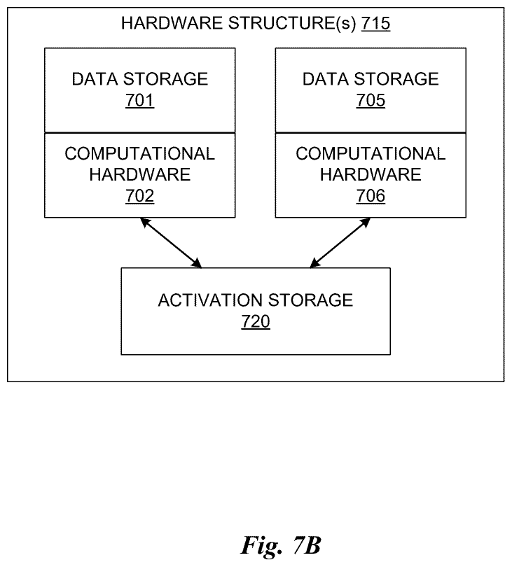

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

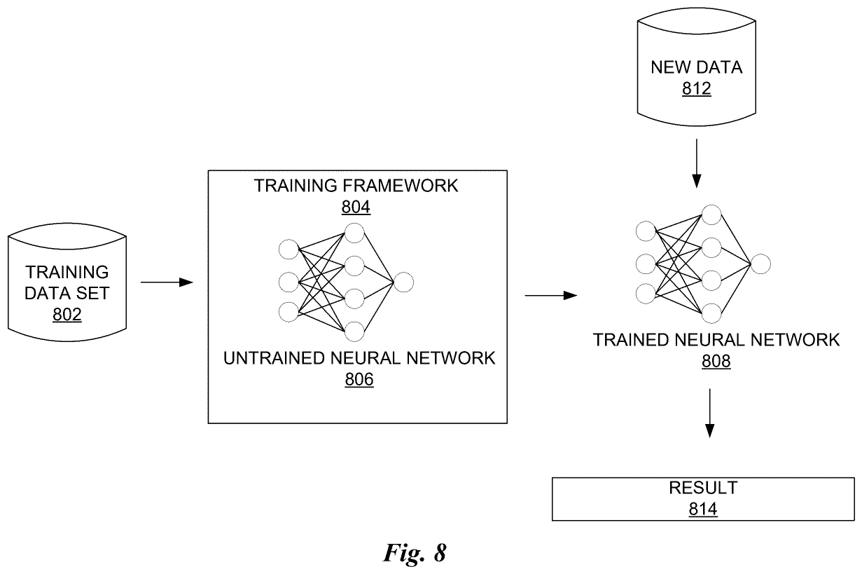

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

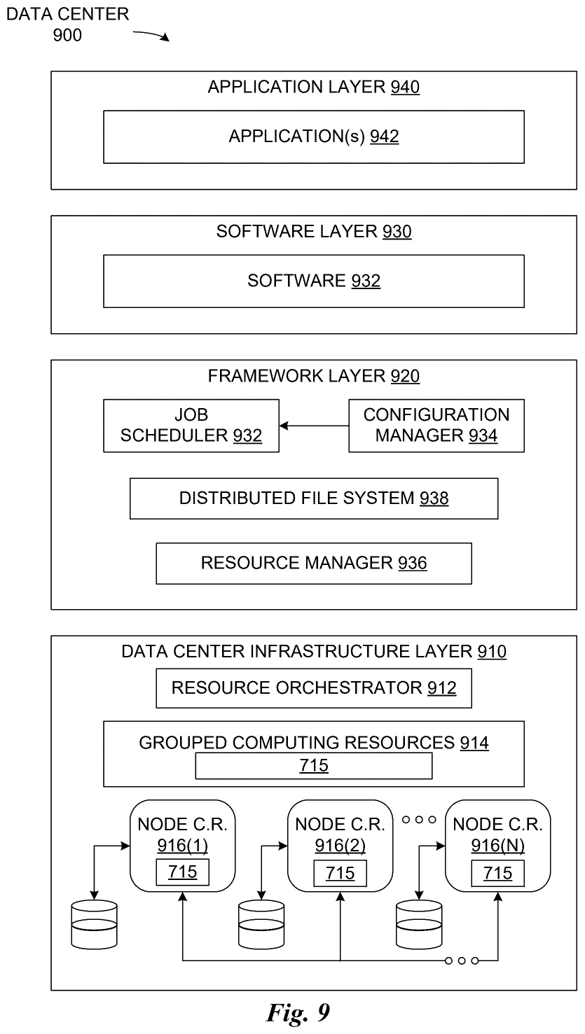

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed for generating a robotic motion plan. In accordance with FIGS. 1-6, embodiments may provide machine learning models usable for performing inferencing operations and for providing inferenced data. The machine learning models may be stored (partially or wholly) in one or both of data storage 701 and 705 in inference and/or training logic 715 as depicted in FIGS. 7A and 7B. Training and deployment of the machine learning models may be performed as depicted in FIG. 8 and described herein. Distribution of the machine learning models may be performed using one or more servers in a data center 900 as depicted in FIG. 9 and described herein.

What is claimed is:

1. A method, comprising:
at a device:
processing a natural language prompt describing a robotic goal, using a language model, to generate constraints for a task and motion planning (TAMP) system; and
generating a motion plan, by the TAMP system, that respects the constraints and achieves the robotic goal.

2. The method of claim 1, wherein the language model is a large language model (LLM).

3. The method of claim 1, wherein the language model is a vision-language model (VLM).

4. The method of claim 1, wherein the constraints are generated in a vocabulary of the TAMP system.

5. The method of claim 1, wherein the constraints define goal conditions.

6. The method of claim 5, wherein the constraints include at least one continuous constraint over a decision variable to define the goal conditions.

7. The method of claim 1, wherein the constraints define a partial plan.

8. The method of claim 7, wherein the constraints include at least one discrete constraint over an action sequence to specify the partial plan.

9. The method of claim 1, wherein the language model is grounded with a set of reachable actions and a set of reachable literals representing reachable states.

10. The method of claim 9, wherein the set of reachable actions and the set of reachable literals are both grounded from a given initial state.

11. The method of claim 10, wherein the language model:
determines as a first one of the constraints a subset of the reachable literals that conjunctively must hold to satisfy the robotic goal described by the natural language prompt, and
determines as a second one of the constraints a partial plan comprised of a subset of the reachable actions that achieve the robotic goal described by the natural language prompt.

12. The method of claim 11, wherein the TAMP system is constrained to generating a motion plan that includes the partial plan as a subsequence.

13. The method of claim 1, further comprising, at the device:
outputting the motion plan to a robotic system.

14. The method of claim 13, wherein outputting the motion plan to the robotic system causes the robotic system to move in accordance with the motion plan to achieve the robotic goal.

15. The method of claim 13, wherein the robotic system is a real-world robotic system.

16. The method of claim 15, wherein the real-world robotic system is a robotic arm.

17. The method of claim 15, wherein the real-world robotic system is an autonomous driving vehicle.

18. The method of claim 13, wherein the robotic system is a virtual robotic system.

19. The method of claim 18, wherein the robotic system is a character or other movable object in a video game.

20. The method of claim 1, further comprising, at the device:
iteratively reprompting the language model to refine the constraints.

21. The method of claim 20, wherein the language model is reprompted based on a function that tests over a set of sampled continuous variables of a domain of the constraints' parameters.

22. The method of claim 21, wherein the function is generated by the language model or by another language model.

23. A system, comprising:
a non-transitory memory storage comprising instructions; and
one or more processors in communication with the memory, wherein the one or more processors execute the instructions to:
process a natural language prompt describing a robotic goal, using a language model, to generate constraints for a task and motion planning (TAMP) system; and
generate a motion plan, by the TAMP system, that respects the constraints and achieves the robotic goal.

24. The system of claim 23, wherein the language model is one of a large language model (LLM) or a vision-language model (VLM), and wherein the constraints are generated in a vocabulary of the TAMP system.

25. The system of claim 23, wherein the constraints define goal conditions and a partial plan.

26. The system of claim 23, wherein the one or more processors further execute the instructions to:
output the motion plan to a robotic system to cause the robotic system to move in accordance with the motion plan to achieve the robotic goal.

27. A non-transitory computer-readable media storing computer instructions which when executed by one or more processors of a device cause the device to:
process a natural language prompt describing a robotic goal, using a language model, to generate constraints for a task and motion planning (TAMP) system; and
generate a motion plan, by the TAMP system, that respects the constraints and achieves the robotic goal.

28. The non-transitory computer-readable media of claim 27, wherein the language model is one of a large language model (LLM) or a vision-language model (VLM), and wherein the constraints are generated in a vocabulary of the TAMP system.

29. The non-transitory computer-readable media of claim 27, wherein the constraints define goal conditions and a partial plan.

30. The non-transitory computer-readable media of claim 27, wherein the device is further caused to:
output the motion plan to a robotic system to cause the robotic system to move in accordance with the motion plan to achieve the robotic goal.
